(19) United States
(12) Patent Application Publication
(10) Pub. No.: US 2013/0298943 A1
(43) Pub. Date: Nov. 14, 2013

(54) CLEANING STATION FOR CLEANING WELDING TORCHES

(71) Applicant: Dines G.m.b.H., Hamburg (DE)

(72) Inventor: Peter Zander, Norderstedt (DE)

(73) Assignee: DINES G.M.B.H., Hamburg (DE)

(21) Appl. No.: 13/893,377

(22) Filed: May 14, 2013

(30) Foreign Application Priority Data
May 14, 2012 (EP) 12 167 853.6

(51) Int. Cl. B23K 9/32

(52) U.S. Cl. CPC B23K 9/328
USPC 134/8; 15/304; 15/308

(57) ABSTRACT

A cleaning station and method for cleaning welding torches disposed on welding robots, in particular a cleaning station and method for cleaning the interior of gas nozzles on electrical arc welding torches, which has a simpler and more robust construction, while at the same time having a reliable cleaning effect. The cleaning station has a cleaning wire, one end of which is attached on one side to a base and extends from the base towards a free end, wound in a coil around a longitudinal axis, wherein the outer diameter of the coil formed by the cleaning wire is dimensioned in such a way that the coil at the free end of the cleaning wire is inserable, at least along a section of its length, into a welding torch, especially into a gas nozzle of an electrical arc welding torch.

### BACKGROUND OF THE INVENTION

1. Technical Field

The present invention relates to a cleaning station for cleaning welding torches disposed on welding robots, in particular the interior of gas nozzles on electrical arc welding torches. It further relates to a method of cleaning such a welding torch.

2. Background Information

Welding robots are used to create welded seams, for example spot welding, in various manufacturing processes, in which metal elements are firmly connected to one another. Here, electrical arc welding processes in particular are used; in this case, gas-shielded metal arc welding processes (GMAW-processes) in particular. In the case of gas-shielded metal arc welding, a distinction is made between so-called MIG welding (metal inert gas welding) and MAG welding (metal active gas welding, i.e, using reactive gases). In these processes, the melting welding wire is continuously fed in by a wire feed unit having a variable speed.

In the course of various welding procedures, the welding torches, and in the case of electrical arc welding devices, especially gas-shielded metal arc welding devices, in particular the inside area of the gas nozzles disposed on the corresponding devices, become contaminated. Such contamination can lead to malfunctions and unsatisfactory welded seams in the final results, or can lead to the failure of the welding device due to welding currents deflected via weld splash (short circuits), and thus may lead to a complete failure of the welding system.

Accordingly, the welding torches disposed on welding robots must be cleaned at regular intervals, and associated welding residues, especially splashes of molten metals, must be removed and the welding torches cleaned. It is known that the welding torches, in particular the interior of the gas nozzles of electrical arc welding torches, can be cleaned using rotating wire brushes, which are driven around a rotational axis in an the axial direction of the rotational axis, and which are inserted into the front end of the welding torch being cleaned, especially into the gas nozzle of an electrical arc welding torch, where the rotation of the brush end dislodges weld splash adhering to the inner wall of the welding torch, especially of the gas nozzle. For this purpose, the welding torches are moved to a cleaning station through an appropriate approach movement by the welding robot on which cleaning station the rotating wire brushes are disposed, and the rotating wire brushes are moved into the front ends of the welding torches facing the welding seam and there, exert the cleaning effect.

While a good cleaning performance can be achieved with these kinds of cleaning stations, they nevertheless require a complex structure and accurate operation in order to deploy the cleaning effect. In particular, drives must be provided on the one hand for the rotation of the wire brushes, and on the other for the longitudinal adjustment of those brushes, and exact alignment must be maintained between the path of the rotational axis of the wire brush, and the longitudinal orientation of the welding torch disposed on the robot arm. In addition, the wire brushes are subject to wear, and must be periodically removed and replaced.

### SUMMARY

The task of the present invention is therefore to specify a cleaning station for cleaning welding torches disposed on welding robots, in particular the interior of gas nozzles on electrical arc welding torches, which has a simpler and more robust construction, while at the same time having a reliable cleaning effect. Furthermore, a corresponding cleaning process is to be specified.

This task is achieved according to the invention by a cleaning station for cleaning welding torches disposed on welding robots, in particular the interior of gas nozzles on electrical arc welding torches.

According to the invention, a cleaning station for cleaning welding torches disposed on welding robots, in particular the interior of gas nozzles on electrical arc welding torches, which solves the above described task, has a cleaning wire, one end of which is attached on one side to a base, and which extends from the base towards a free end, wound in a coil around a longitudinal axis. Here, the outer diameter of the coil formed by the cleaning wire is dimensioned in such a way that the coil at the free end of the cleaning wire can be inserted, at least along a section of its length, into a welding torch, especially into a gas nozzle of an electrical arc welding torch. Such an insertion into a welding torch, especially into a gas nozzle of an electrical arc welding torch, is made from an open welding and processing side. It is thereby to be understood that insertion does not necessarily mean that the cleaning wire itself is moved in the direction of the inside of the gas nozzle. Rather, it can be the welding torch itself—and in the sense of the invention, it is advantageous if it is the welding torch itself—that is guided over the immobile coil of the cleaning wire by means of the welding robot so that the free end of the cleaning wire and the facing section of the coil enter the welding torch, especially the gas nozzle of an electrical arc welding torch.

If the welding torch is now moved back and forth—which can be done by appropriately programming the welding robot and its multi-axis movements—in relation to the cleaning wire, especially transverse to the longitudinal axis of the coil, or in the direction of that longitudinal axis, the cleaning wire—supported by the coiled shape—strikes the inner walls inside the welding torch, especially the gas nozzle, wherein there is not only a longitudinal or transverse movement relative to the longitudinal direction of the coil, but due to the coiled shape of the cleaning wire, there is also a movement component in the respective other direction relative to the longitudinal axis of the coil. Contaminates, especially hardened metal droplets that adhere to the interior of the welding nozzle, are removed from the welding torch through this repeated striking with different directional components, and can fall out of the front end of the welding torch (the end turned towards the welding seam during processing). In this way and using the method outlined, (which itself has inventive content), a contaminated welding torch can be cleaned for further use in a very short time and using very simple means. The cleaning station is thereby constructed using the simplest means and is very robust. In particular, the cleaning wire is now subject to barely any wear and has a significantly longer service life than known wire brushes. In the cleaning station according to the invention, it is essential that only one end of the cleaning wire is attached to the base on one side, and otherwise has no other attachment. In addition, the coiled shape into which the cleaning wire is wound is essential, since this shape causes and promotes the above described, repeated striking of the cleaning wire on the walls inside the welding torch, especially the gas nozzle of an electrical arc welding torch.

The longitudinal axis of the coil of the cleaning wire advantageously runs essentially vertically in the cleaning station according to the invention, This orientation offers the advantage that the welding torch, having a downward facing outlet pointed towards the welding point in the welding application, is guided over the cleaning wire that is wound into a coiled form, so that dislodged contamination can escape form this opening through the effect of gravity, and simply fall out of the welding torch.

In order to catch and collect cleaning residues that are removed from the welding torch, especially hardened metal droplets in the cleaning station, it is advantageous if a containment is provided, disposed below the base and below the coil, to catch these kinds of cleaning residues.

The cleaning wire is advantageously composed of spring steel. A cleaning wire composed of spring steel and wound into a coil provides a particular elasticity and supports the cleaning effect of the back and forth striking by the cleaning wire when the coil is made to vibrate by the corresponding movement of the welding torch as generated by the welding robot. This substantially promotes the cleaning effect.

It is especially advantageous that the cleaning wire is wound into a cylindrical coil, in particular in the manner of a helical spring. A cylindrical coil of this sort has the advantage that a greater length of that coil can be inserted into a given outlet opening of a welding torch, especially a gas nozzle of an electrical arc welding torch, and can exert an effect there. Further, this coil can be sized in such a way that a contact tip or a welding torch (especially an electrical arc welding torch) can be inserted into is interior in an axial direction and accommodated there so that the cleaning wire can also remove contamination attached to this component. If the cleaning station according to the invention is to be used in conjunction with welding torches, the outlet openings of which are of differing diameters, however, other coil shapes of the cleaning wire can be considered, for example a coil that apers conically towards its free end.

In a further modification of the invention that is not essentially necessary for an implementation of the invention, but that brings with it certain advantages, the cleaning device itself has an actuator for the driven back and forth movement of the cleaning wire wound into a coil in a direction that is longitudinal to and/or transverse to the longitudinal axis. This kind of active configuration with an actuator for the back and forth movement of the coil-shaped cleaning wire can be selected as support or even as a replacement, especially when a back and forth motion of the welding torch generated by the robot arm is not sufficient for an adequate cleaning effect with the cleaning wire. If the cleaning effect is sufficient, however, a purely passive design of the cleaning station is preferred, that is, without a separate actuator drive for the back and forth movement of the cleaning wire wound into a coil in a direction that is longitudinal to and/or transverse to the longitudinal axis.

The cleaning effect can be further supported by providing a pressurized gas line in the cleaning station having an outlet nozzle in the area of the cleaning wire, through which a flow of pressurized gas can be applied in in a direction having at least one directional component pointed in the direction of the free end of the coil. With such a pressurized gas source, the interior of the welding torch can be blown out during or at the end of the cleaning process, and freed of fine debris.

The cleaning device according to the invention advantageously includes a stand, the lower section of which rests on a subsurface and on an upper section of which, the base with the attached cleaning wire is disposed. Such a stand allows the cleaning wire to be disposed at a suitable working height, which, on one hand, can be easily approached by the welding robot and the welding torch disposed thereon, and which, on the other hand, is easily accessible to the operator or maintenance personnel.

The cleaning device according to the invention can have other elements besides the cleaning wire. In particular, these may include a cutting device for clipping a free end of a welding wire that is inserted into the welding torch, wherein in particular, this cutting device can be fastened to the stand. It is important, especially in the case of gas-shielded metal arc welding, that the welding torch be guided to the welding point that is to be approached with a defined length of the freely projecting section of the welding wire in order to obtain an accurate welding result. The length of the welding wire is typically measured and tracked via the wire feeder device. This is not always precise, however, due to slippage and other tolerances, wherein the precision is reduced, especially after a longer welding process. In addition, cleaning can bend the end of the welding wire or can cause other changes to the welding wire, so accurately cutting the tip of the welding wire after finishing a cleaning procedure can also be advantageous for this reason as well. With the cutting device according to the invention, precisely adjusting the position of the robot makes it possible to clip the free end of the welding wire such that the free end of the welding wire disposed in the welding torch has a very precise remaining length.

A further, additional function of the cleaning device can be obtained with an essentially horizontally disposed directional plate composed of an electrically conductive material, in which said plate has two contact edges oriented perpendicular to one another, against which the welding wire of a welding torch can be guided. This directional plate can especially be disposed on the stand, if the cleaning station has such a stand. The directional plate is provided in order to check or readjust the correct position of the so-called Tool Center Point (TCP), or in other words the reference point for the position of the tool, which is predetermined by the position of the free end of the welding wire, after a cleaning process and clipping of the free end of the welding wire. In so doing, the welding robot runs the welding torch successively to the two contact edges oriented at right angles to one another, wherein the contact is indicated to the system by an incoming current flow of the welding wire, which is supplied by an electrical supply, upon contact with the contact edge of the electrically conductive directional plate. Because the position of the directional plate is firmly spatially disposed, and because its position coordinates are known by the welding robot, the welding robot can determine the position of the TCP based on its movement data, can compare this position with its system, and correct this data if needed.

Naturally, a cleaning station is not solely limited to a single cleaning wire disposed there and thus, for example, tandem or twin stations can be configured having two cleaning wires for simultaneous use by, and cleaning of, two welding torches, or stations may be configured having more than two approachable cleaning wires for a corresponding number of welding torches.

### BRIEF DESCRIPTION OF SEVERAL VIEWS OF THE DRAWINGS

Further advantages and features of the invention will become apparent from the following description of an embodiment based on the accompanying figures. The drawings show:

FIG. 1 a view in perspective of an embodiment of a cleaning station according to the invention;

FIG. 2 a front view of the cleaning station in accordance with FIG. 1;

FIG. 3 a sectional view along the cutting plane A-A in FIG. 2;

FIG. 4 an enlarged view of the detailed view in FIG. 3 designated as IV;

FIG. 5 a top view from above the embodiment of the cleaning station in accordance with the preceding figures;

FIG. 6 a sectional view of the embodiment comparable to FIG. 3, having a welding torch with an opening on the welding side above the welding torch guided by the cleaning wire and

FIG. 7 an enlarged view of the section in FIG. 6 designated as VII.

The figures show an embodiment of a cleaning station according to the invention for explanatory purposes. This embodiment will be described below with reference to these figures. It should be noted here that the figures by no means represent complete design representations and are not necessarily shown to scale. Rather, they serve as the basic illustration and explanation of the construction and operation of the cleaning station in an exemplary embodiment, and therefore do not represent an exhaustive illustration of all design variants that are conceivable and possible within the context of the invention. Identical elements have been given the same reference numbers in the figures.

### DETAILED DESCRIPTION

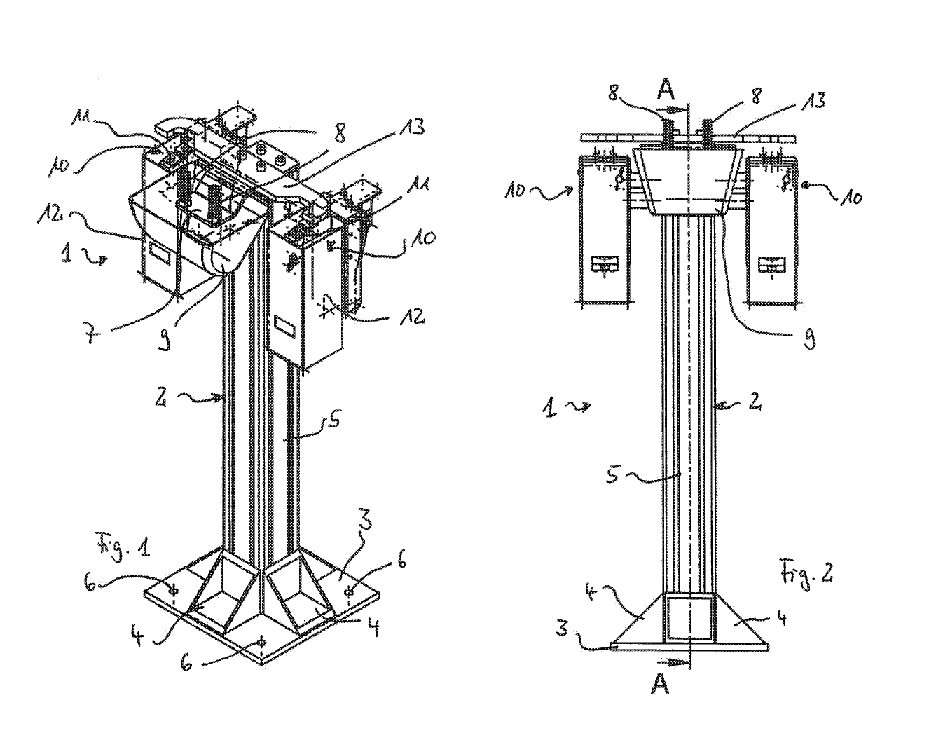

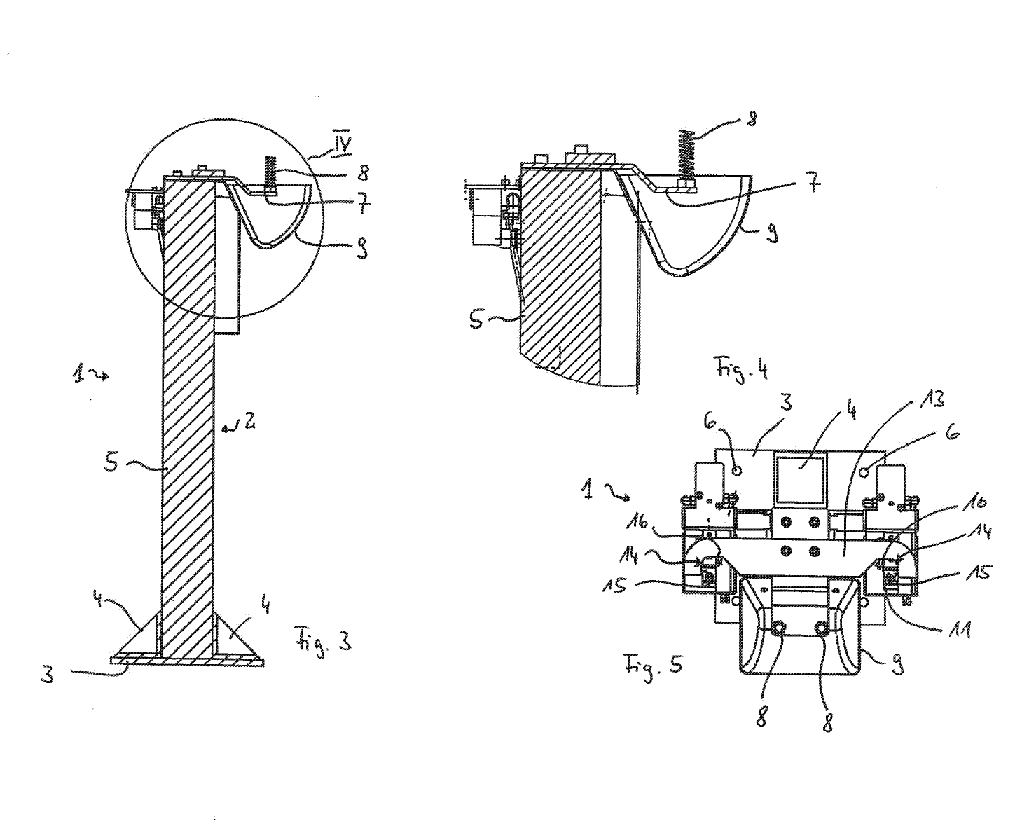

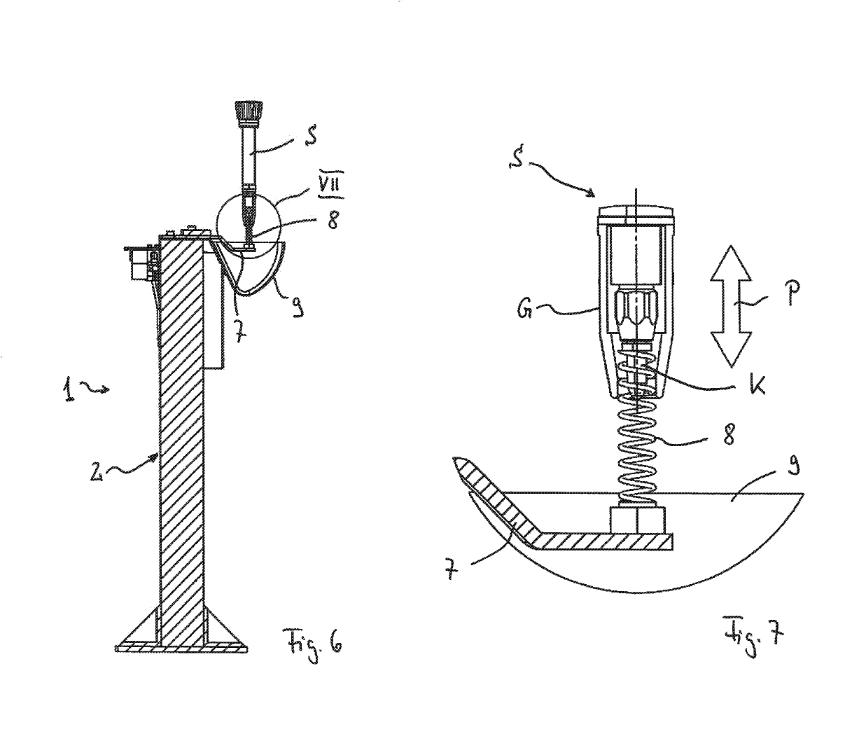

A cleaning station according to the invention is generally designated as 1 in the figures. The structure of that cleaning station is described below primarily referencing FIGS. 1 to 5. In terms of the function of the cleaning station, reference is made to the illustrations in FIGS. 6 and 7, which likewise again reveal the essential elements of the cleaning station 1. The cleaning station 1 includes a pillar-like stand 2, which includes a fixed vertical strut 5 that is positioned on a floor plate 3, and fastened there with gussets 4. The floor plate 3 is pierced by fastening holes 6, through which the floor plate 3 can be accurately positioned by means of suitable screws, anchors or the like.

The actual functional components of the cleaning station 1 are disposed at the upper end of the vertical strut 5. Here, the cleaning station 1 that is shown is a tandem station,—constructed here as mirror images of one another—which bears two of each functional component for simultaneous use by two welding robots, for cleaning the welding torches disposed on each of these robots.

A principal element of the functional components of the cleaning station are two cleaning wires 8 wound into a coiled shape in this case on a shared base 7, which is formed as a double-angled plate. One end of each of the cleaning wires 8 is disposed on the base 7 and wound into a cylindrical, helical spring-like coil, which extends in a longitudinal direction in an essentially vertical direction extending freely from the base 7 without further fixing points. The cleaning wires 8 are composed of spring steel, so that they each form a cylindrical form typical of helical springs when wound into a coil.

A trough-like containment vessel 9 is disposed below the base 7 and the cleaning wires 8, into which contamination freed from a welding torch, especially hardened metal droplets, fall and are caught and collected during cleaning in a manner described in greater detail below.

There are cutting devices 10 located to the right and left of the containment vessel 9 for clipping a free end of a welding wire guided into the welding torch. In these cutting devices, the protruding portions of the welding wire is cut off with claw-shaped cutting jaws, which are schematically indicated here as 11 and which work in a manner similar to cutting pliers for clipping the end of a wire, wherein the cut ends fall into the containment vessel 12 disposed below the cutting jaws 11 and are collected there.

Also evident is a generally yoke-shaped directional plate 13, which is disposed on the upper end of the vertical strut 5 of the stand 2 and which extends to both sides of the containment vessel 9. On either side of the containment vessel 9, the directional plate 13, which is composed of an electrically conductive material, has recesses 14, each with two contact edges 15 and 16 oriented perpendicular to one another. These edges serve for the adjustment of the so-called Tool Center Point (TCP), in which the robot runs the welding torch successively to the two contact edges 15 and 16 with the end of the current-conducting welding wire, wherein a change in the current flow occurs when the welding wire comes into contact with the conductive material of the directional plate on the contact edges 15 or 16, wherein this change is interpreted by the controls of the robot as contact with the known contact edges 15 or 16 in terms of the respective position in the x- or y-axis of a virtual coordinate system and the position of the TCP determined therefrom, that change is compared to the stored value and the stored coordinates for this point are corrected if necessary.

This step is typically the last step in the cleaning process. Prior to this, the welding robot travels with the welding torch above the coiled cleaning wire 8 composed of spring steel, which is wound into a helical spring, lowers the welding torch S to a position as shown in FIG. 6 and as represented as an enlarged section in FIG. 7, so that the cleaning wire 8 with its free end of the coil is inserted into the welding torch S, especially into the gas nozzle G of the welding torch S, shown here as an electrical arc welding torch designed especially for MIG or MAG welding. Here, the dimensions of the coil of the cleaning wire 8 are such that the contact tip K of the welding torch S fits and is accommodated in the space that extends axially in a longitudinal direction and between the windings of the cleaning wire 8. From this initial position, the welding robot then makes a rapid back and forth movement with the welding torch S in the longitudinal direction of the coil of the cleaning wire 8, or transversely thereto, (in this case, movement is in a longitudinal direction indicated by the arrow P), so that the cleaning wire 8 strikes the inner wall of the interior of the welding torch S, here especially its gas nozzle G, and also the outside of the contact tip K repeatedly and in different directions and in this way, loosens contamination adhering there, especially hardened metal droplets, which then fall out due to gravity and are collected in the trough-like containment vessel 9.

The cleaning effect achieved with this approach is sufficient even after a short period of back and forth movements by the welding robot, so that the welding robot can then run the welding torch S to the associated cutting device 10 (the cutting device 10 located closer to the assigned cleaning wire 8) and clip or trim the welding wire to the precise length. For this purpose, the welding robot will position the welding torch S at a predetermined height in such a way that the welding wire lies between the cutting jaws 11, upon which a feed motion of the cutting jaws 11 is triggered and the welding wire is clipped. The above described determination and control of the TCP occurs prior to or subsequent to this. The welding robot with the cleaned welding torch S is subsequently ready for use in further welding processes.

The embodiment of a cleaning station 1 shown here is purely passive in terms of the cleaning process, that is, the mechanical cleaning effect between the welding torch S (especially the inside of a gas nozzle G of an electrical arc welding torch) and the cleaning wire 8 is achieved purely on the basis of the movement of the welding torch S, which is initiated by the welding robot. It is also conceivable that an actuator could be provided on the cleaning station itself, wherein that actuator triggers and generates a back and forth movement of the coiled cleaning wire 8 in a direction that is longitudinal or transverse to the longitudinal extension of the coil. It is also conceivable (not shown here) that the cleaning device additionally be equipped with a pressurized gas source, for example a pressurized air source, in order to blow out the welding torch S during or subsequent to the cleaning so that any debris that remains in the welding torch S is removed.

### REFERENCE LIST

1 cleaning station
2 stand
3 floor plate
4 gusset
5 vertical strut
6 fastening hole
7 base
8 cleaning wire
9 containment vessel
10 cutting device
11 cutting jaws
12 containment vessel
13 directional plate
14 recess
15 contact edge
16 contact edge
G gas nozzle
K contact tip
P arrow
S welding torch

1. A cleaning station for cleaning welding torches disposed on welding robots, in particular the interior of gas nozzles on electrical arc welding torches, said cleaning station comprising:
a base; and
a cleaning wire, one end of which is attached to the base, and wherein the cleaning wire extends from the base towards a free end and is wound in a coil around a longitudinal axis, wherein an outer diameter of the coil formed by the cleaning wire is dimensioned in such a way that the coil is adapted to be insertable, at least along a section of its length, into a welding torch, especially into a gas nozzle of an electrical arc welding torch.

2. The cleaning station according to claim 1, wherein the longitudinal axis of the coil of the cleaning wire extends essentially vertically.

3. The cleaning station according to claim 1 further comprising a containment vessel disposed below the base and below the coil for collecting cleaning residues.

4. The cleaning station according to claim 1 wherein the cleaning wire is composed of spring steel.

5. The cleaning station according to claim 1 wherein the cleaning wire is wound in a cylindrical coil.

6. The cleaning device according to claim 1 further comprising an actuator for driving a back and forth movement of the cleaning wire wound into the coil in a direction that is longitudinal and/or transverse to the longitudinal axis.

7. The cleaning station according to claim 1 further comprising a pressurized gas line terminating in an outlet nozzle in the vicinity of the cleaning wire in order to apply a flow of compressed gas in a direction having at least one directional component pointed in the direction of the free end of the coil.

8. The cleaning device according to claim 1 further comprising a stand a lower section of which is adapted to rest on a subsurface and wherein the base with the attached cleaning wire is disposed on an upper section of the stand.

9. The cleaning device according to claim 8, further comprising a cutting device disposed adjacent the cleaning wire in order to clip a free end of a welding wire guided inside the welding torch.

10. The cleaning device according to claim 1, further comprising directional plate consisting of an electrically conductive material that is disposed essentially horizontal and having two contact edges that are oriented perpendicular to one another, against which a welding wire of a welding torch is guidable.

11. A method of cleaning welding torches disposed on welding robots, wherein an open end of a welding torch that is to be cleaned is guided over a free end of a cleaning wire that has been wound into a coil and fastened at one end to a base, and the welding torch is moved back and forth relative to the cleaning wire in such a way that the cleaning wire strikes an inner wall inside the welding torch.

12. The cleaning device according to claim 9, wherein the cutting device is fastened to the stand.

13. The cleaning device according to claim 10, further comprising a stand, a lower section of which is adapted to rest on a subsurface; and the base with the attached cleaning wire is disposed on an upper section of the stand; and
wherein the directional plate is disposed on the stand adjacent the base.

14. The method according to claim 11, wherein the welding torch is an electrical arc welding torch and the welding torch is moved back and forth relative to the cleaning wire in such a way that the cleaning wire strikes an inner wall of a gas nozzle on the welding torch.
